(19) United States
(12) Patent Application Publication
(10) Pub. No.: US 2011/0026388 A1
(43) Pub. Date: Feb. 3, 2011

(54) METHOD FOR CALIBRATION FOCUSING ERROR SIGNAL OF LIGHTSCRIBE DISC

(76) Inventors: Chun-Wen Lai, Taoyuan County (TW); Wei-Ting Huang, Taoyuan County (TW); Chi-Hsiang Kuo, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/824,234

(22) Filed: Jun. 28, 2010

(30) Foreign Application Priority Data
Jul. 28, 2009 (TW) 098125469

(51) Int. Cl. G11B 27/36

(52) U.S. Cl. 369/53.31; G9B/27.052

(57) ABSTRACT

A method for calibrating a focusing error signal of a lightscribe disc includes the following steps. An optical pickup head is moved to a focusing reference surface by utilizing radial voltages to some predetermined measuring positions to find and record the best gain value used to calibrate the asymmetry of the focusing error signal. The best gain fitting curve is formed by curve-fitting, based on the recorded radial voltages and the best gain values. The best gain value is obtained by an interpolation or extrapolation method, and used to calibrate the asymmetry of the focusing error signal of a lightscribe disc.

### BACKGROUND OF THE INVENTION

1. Field of the Invention

The present invention relates to an optical disc drive, and more particularly, to a method of calibrating focusing error signal asymmetry when a pickup head focuses on an inner ring of a label side of a lightscribe disc.

2. Description of the Prior Art

A conventional optical disc has two sides, one being a data side and the other a label side, and a traditional method of labeling the disc is by marking the label side with a pen or a label sticker. A lightscribe label technology has been recently developed, which utilizes a pickup head of an optical disc drive to direct a laser ray to scribe figures or text on the label side of a lightscribe disc, so as to fabricate an artistic and customized optical disc.

This is shown in FIG. 1, which is a diagram of a pickup head reading a label side of a lightscribe disc according to the prior art. The optical disc 10 includes a control feature zone 11, and 400 spokes 12 arranged at an inner ring of the label side of the optical disc 10, and distributed on the inner side of the control feature zone 11 with equal angles. By reading and determining a spoke 12, a relative angle position can be provided for the pickup head 20 to perform scribing. The outer side of the control feature zone 11 provides related data marks for the optical disc 10, e.g., media ID field, saw-tooth pattern and index mark, etc. Additionally, a data zone and a non-data zone are discriminated by materials with notably different reflection rates.

Since there are differences between fabricating companies, processes and materials of the optical disc 10, the pickup head 20 has to read related information recorded in the control feature zone 11 of the optical disc 10 before starting scribing correct figures and text in a label zone 13, so as to adjust strategy parameters of scribing the optical disc 10 to an optimized state. When reading information, the conventional pickup head 20 utilizes different voltages to form an electromagnetic force, driving a lens 22 supported by a spring line 21, and beaming a laser ray to the control feature zone 11 of the lightscribe disc 10 rotated by a spindle motor 23, referring to the luminous flux of a spot 25 received by illuminated parts A, B, C and D in a light detector 24, calculating (A+C)−(B+D) and utilizing an amplifier 26 to amplify the signal, thereby deriving a focusing error (FE) signal. Utilizing a focusing error signal S-curve going through zero makes the lens 22 focus at the control feature zone 11 for the pickup head 20 to read information in the control feature zone 11 correctly.

A light path design, fabrication or assembly error may lead to asymmetric illumination between illuminated parts (A+C) and (B+D), leading to focusing error signal asymmetry between the upper part and lower part, and therefore incorrect focusing. Although the prior art can utilize a fixed gain G to calibrate the illuminated parts to make FE=G(A+C)−(B+D) to eliminate the asymmetry of the focusing error signal, the fixed gain G is derived from the center of the pickup head 20 by the lens 22. When the lens 22 is away from the center of the pickup head 20, the asymmetry of spot 25 will also change with a variation of the light path and angle of the lens 22. The fixed gain G is either too large or too small for the other positions of the lens 22, and therefore the asymmetry of the focusing error signal cannot be alleviated and may even degrade such that the focusing cannot be performed correctly. More particularly, when reading information in the control feature zone 11 of the lightscribe disc 10, the focusing error signal is not very good; in addition, the non-data mark zone is made with materials of a worse reflection rate, so a smaller part of the asymmetric focusing error signal will shrink rapidly, and the focusing error signal will be lost thereby losing focus, which leads to a longer re-reading and focusing time, and lowers the label scribing efficiency. Therefore, there are still problems for the pickup head of a conventional optical disc drive to enhance symmetry of a focusing error signal.

### SUMMARY OF THE INVENTION

One objective of the present invention is to provide a method of calibrating a focusing error signal of a lightscribe disc by calibrating a best gain value of the focusing error signal of a pickup head to improve symmetry of the focusing error signal.

Another objective of the present invention is to provide a method of calibrating the focusing error signal of a lightscribe disc by fitting a best gain curve to enhance focus servo in the control feature zone of the lightscribe disc to lower a chance of focus failure.

Yet another objective of the present invention is to provide a method of calibrating focusing error signal of a lightscribe disc by interpolating or extrapolating a best gain curve to derive a best gain value of a symmetric focusing error signal, and reading data in a control feature zone to facilitate scribing a label.

In order to achieve the aforementioned objectives, the steps of a method according to an exemplary embodiment comprise: setting a focusing reference surface; moving a pickup head to the focusing reference surface; utilizing radial voltages to move a lens to predetermined calibration positions to find and record a best gain value, and calibrating an asymmetry of focusing error signal of each calibration position; fitting a best gain curve according to the recorded radial voltages and the best gain values; and deriving a specific best gain value from the best gain curve according to the radial voltages of the lens to calibrate the asymmetry of the focusing error signal of the lightscribe disc.

In order to achieve the aforementioned objectives, the steps of a method according to an exemplary embodiment comprise: placing a lightscribe disc in an optical disc drive without rotating the lightscribe disc; moving a pickup head to a control feature zone of the lightscribe disc and keeping it still; utilizing different or equal-difference predetermined radial voltages to move a lens to a calibration position to perform focusing to find a focusing error signal and adjust a level of the focusing error signal; searching for a best gain value, correcting an asymmetry of the focusing error signal, and recording a radial voltage and a best gain value of the calibration position; checking the predetermined calibration positions, and fitting a best gain curve according to the recorded radial voltages and best gain values; and reading a control feature zone, and deriving a specific best gain value from the best gain curve according to a radial voltage of driving a lens to calibrate an asymmetry of the focusing error signal of the lightscribe disc.

Another exemplary method for calibrating a focusing error signal of a lightscribe disc comprises: placing a lightscribe disc in an optical disc drive without rotating the lightscribe disc; moving an optical pickup head to a control feature zone of the lightscribe disc and keeping it still; utilizing a predetermined radial voltage to move a lens to a calibration position to perform focusing to find a focusing error signal and adjust a level of the focusing error signal; searching for a best gain value, correcting an asymmetry of the focusing error signal, and recording a radial voltage and a best gain value of the calibration position; checking if a predetermined number of calibration positions is reached; when the predetermined number of calibration positions is not reached, fitting a best gain curve according to the recorded radial voltages and best gain values; and reading a control feature zone, and deriving a specific best gain value from the best gain curve according to a radial voltage of driving a lens to calibrate an asymmetry of the focusing error signal of the lightscribe disc.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a pickup head reading a label side of a lightscribe disc according to the prior art.

FIGS. 2(a) to 2(d) are diagrams of a pickup head calibrating a focusing error signal at calibration positions according to an embodiment of the present invention.

FIG. 3 is a diagram of calibrating a focusing error signal in a control feature zone according to an embodiment of the present invention.

FIG. 4 is a diagram of a focusing error signal generated during a calibration process according to an embodiment of the present invention.

FIG. 5 is a diagram of a calibrated best gain curve according to an embodiment of the present invention.

FIG. 6 is a diagram of a best fitting gain value curve according to an embodiment of the present invention.

FIG. 7 is a flowchart of a focusing error signal calibration method of a lightscribe disc according to an embodiment of the present invention.

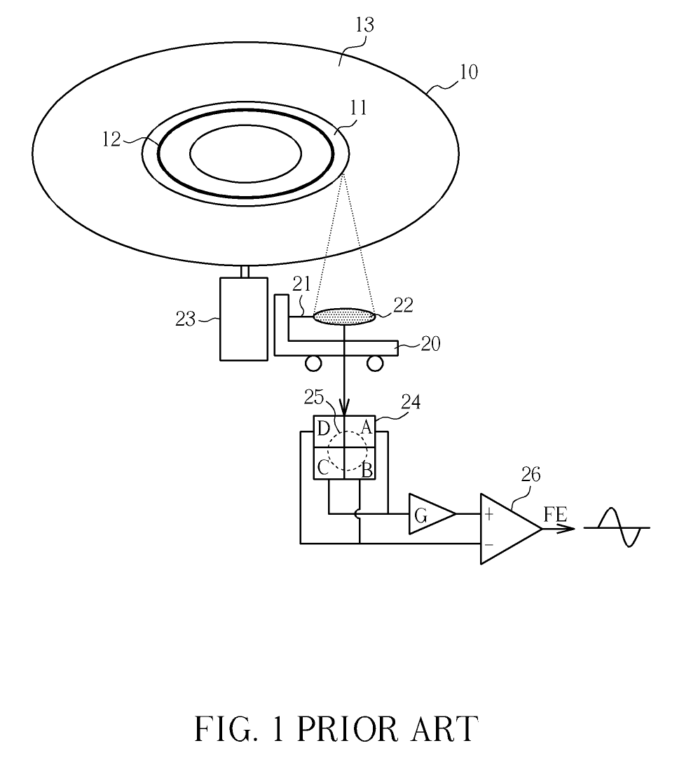

### DETAILED DESCRIPTION

To achieve the aforementioned goals, the methods adopted and the effects thereof are illustrated as follows with exemplary embodiments in accordance with figures.

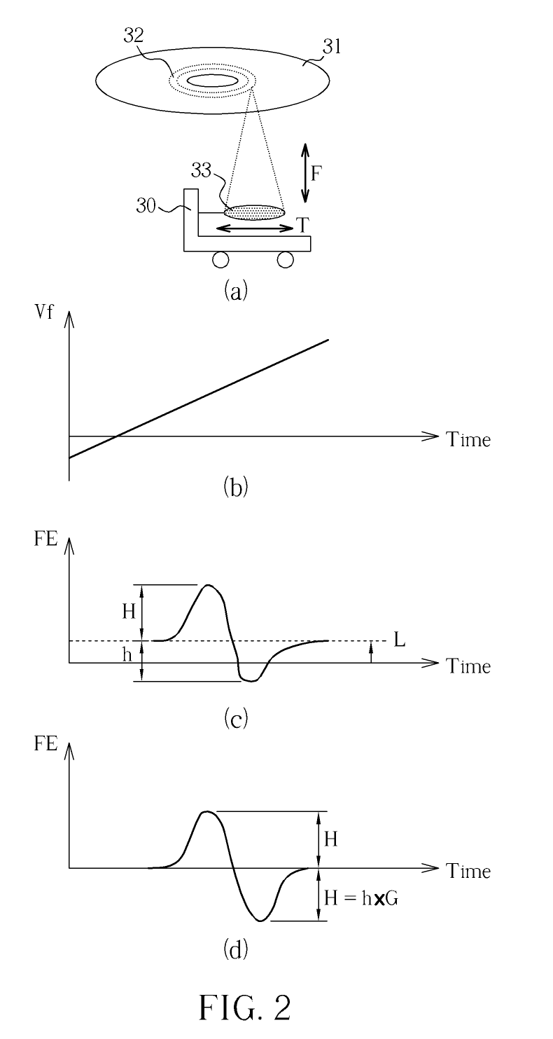

Please refer to FIGS. 2(a) to 2(d), which are diagrams of a pickup head calibrating a focusing error signal at calibration positions according to an embodiment of the present invention. As shown in FIG. 2(a), when calibrating, the pickup head 30 is moved to aim at a focusing reference surface and then stay still, where the focusing reference surface, e.g., a data side of a normal optical disc, is a surface capable of being focused. In this exemplary embodiment, the focusing reference is a control feature zone 32 of the lightscribe disc 31, and the lightscribe disc 31 is poised still without rotating, such as to prevent the data zone and non-data zone, which have different reflection rates, from passing alternately to interfere with the calibration. The pickup head 30 further utilizes a radial voltage Vt to drive the lens 33 to move along a radial direction T parallel to the label side of the lightscribe disc 31 to a calibration position. Next, the focusing voltage Vf is utilized to drive the lens 33 to move along a focusing direction F vertical to the label side of the lightscribe disc 31. As shown in FIG. 2(b), at the calibration position, as the focusing voltage Vf increases with time, the lens 33 is driven to move along the focusing direction F such that the focus point of the projecting light from the lens 33 nears and penetrates the control feature zone 21 to perform focusing. As shown in FIG. 2(c), after the lens 33 finishes focusing at the calibration position, the pickup head 30 will generate an asymmetric focusing error S-curve; a positive half period magnitude H of the focusing error signal is not equal to a negative half period magnitude h of the focusing error signal, and, as a level of the focusing error signal is shifted, a bias voltage of the internal circuits should be adjusted to make the focusing error signal take the level L as reference. As shown in FIG. 2(d), a gain G is derived according to the positive period and the negative period (which have different magnitudes) of the focusing error signal, the negative period magnitude h is multiplied with the gain G to calibrate, such that the positive period magnitude H equals the negative period magnitude h multiplying the gain G, i.e., H=h×G, to derive a best gain value G of the calibration position to finish calibration of the calibration position.

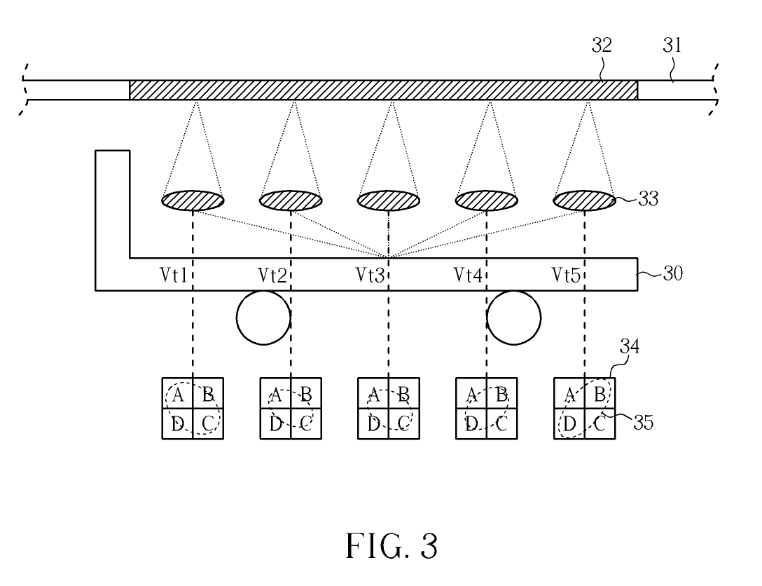

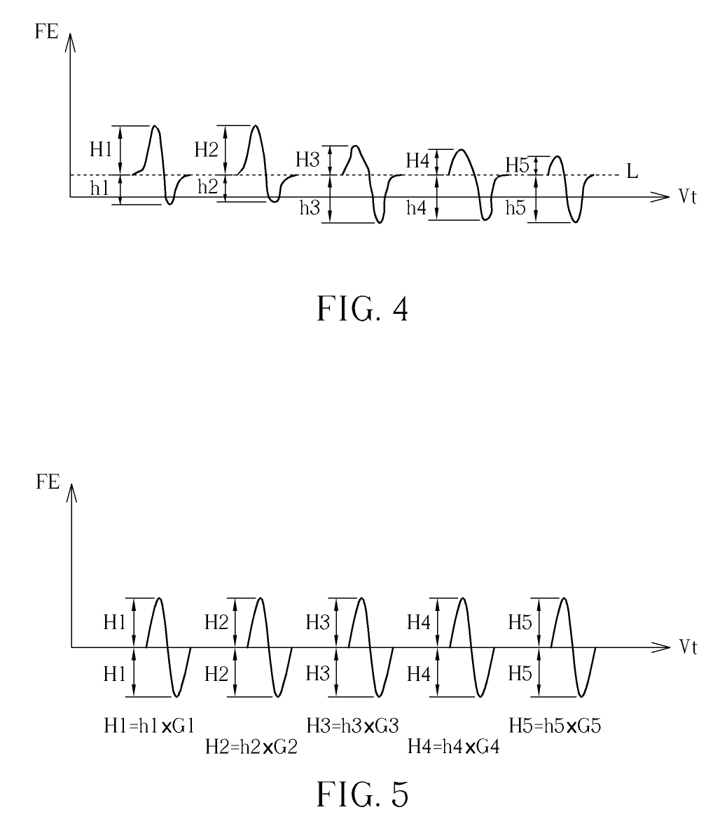

Please refer to FIG. 3, FIG. 4 and FIG. 5 simultaneously. FIG. 3 is a diagram of calibrating a focusing error signal in a control feature zone according to an embodiment of the present invention, FIG. 4 is a diagram of the focusing error signal generated during the calibration process, and FIG. 5 is a diagram of the calibrated best gain curve. As shown in FIG. 3, in this embodiment, the control feature zone 32 of the lightscribe disc 31 is utilized as the focusing reference surface. A radial width of the control feature zone is 650 μm. In the process of calibration, the pickup head 30 stays still to aim at the control feature zone 32; different radial voltages Vt are utilized in the pickup head 30 to drive the lens 33 to multiple distributed calibration positions. In this embodiment, five calibration positions Vt1, Vt2, Vt3, Vt4 and Vt5 are exploited to move the lens 33 to five calibration positions which have an interval of 150 μm. Alight examiner 34 is utilized to receive points 35, which are reflected via the control feature zone 32 from a laser ray, to generate the focusing error signal.

As shown in FIG. 4, referring to the calibration process of the focusing error signal of one single calibration position shown in FIG. 2, focusing is performed for each calibration position to derive S-curves of focusing error signals corresponding to each calibration position. Each S-curve has a positive half period magnitude (H1, H2, H3, H4 and H5) and a negative half period magnitude (h1, h2, h3, h4 and h5), and the level L is adjusted to make the reference of each S-curve identical. As shown in FIG. 5, a best gain value G for each calibration position is searched to adjust the asymmetric focusing error signal of the S-curve of each calibration position, to make the positive half period magnitude equal the negative half period, i.e., H1=h1×G1, H2=h2×G2, H3=h3×G3, H4=h4×G4, H5=h5×G5. Radial voltages Vt1, Vt2, Vt3, Vt4, Vt5 and the corresponding best gain values G1, G2, G3, G4, G5 of each calibration position are recorded.

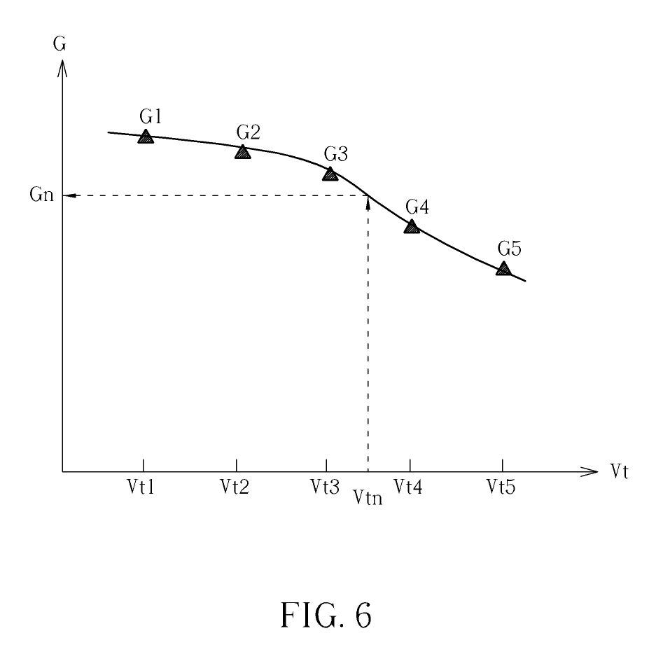

FIG. 6 is a diagram of a best fitting gain value curve. Utilizing the fact that the recorded radial voltages Vt1, Vt2, Vt3, Vt4, Vt5 of each calibration position are horizontal coordinates, and the corresponding best gain values G1, G2, G3, G4, G5 of each calibration position are vertical coordinates, the best gain curve of the pickup head can be fitted. When the pickup head utilizes an arbitrary radial voltage Vtn to drive the lens to move a distance to perform focus servo, a corresponding best gain value Gn can be derived from interpolation or exploration of the best gain curve according to the radial voltage Vtn, such that a positive period magnitude equals a negative period magnitude of the focusing error signal S-curve after calibration (the focusing error signal S-curve is asymmetric before calibration), to achieve the goal of calibrating the symmetry of the focusing error signal.

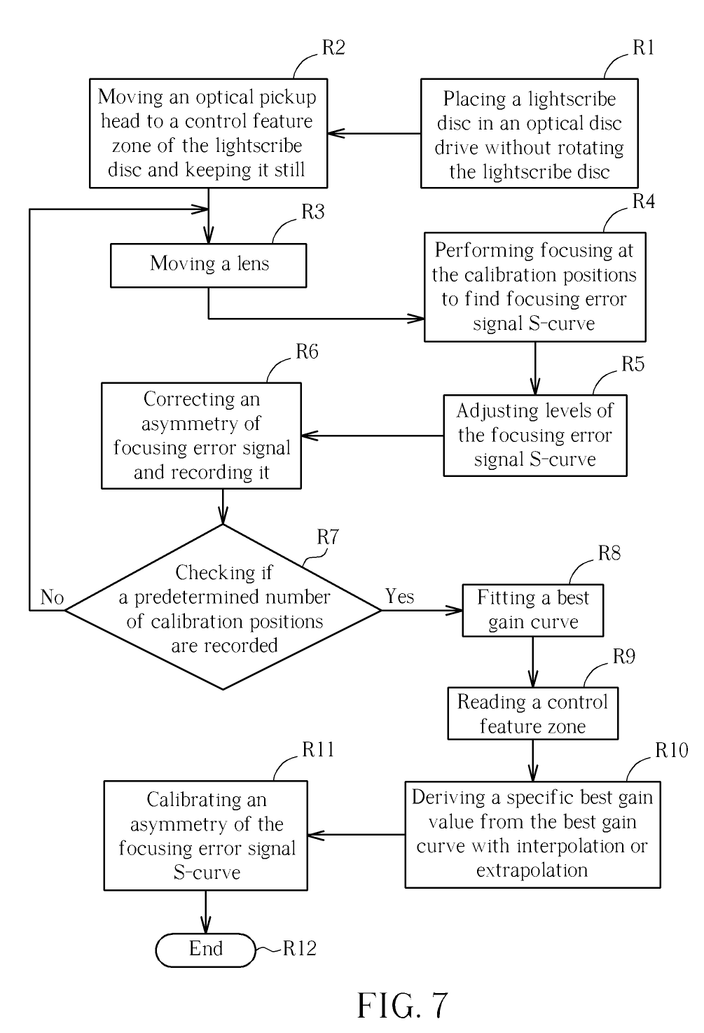

Please refer to FIG. 7, which is a flowchart of focusing error signal calibration method of a lightscribe disc according to an embodiment of the present invention. The steps of calibrating symmetry of the focusing error signal with a best gain curve of the present invention are detailed as follows: starting the calibration process in step R1, placing a lightscribe disc in an optical disc drive without rotating the lightscribe disc, the lightscribe disc aiming at a pickup head; in step R2, moving an optical pickup head to a control feature zone of the lightscribe disc and keeping it still; in step R3, utilizing predetermined radial voltages to move a lens to a calibration position, where the predetermined radial voltages can be different voltages or equal-difference voltages for deriving distributed calibration positions; in step R4, performing focusing at the calibration positions to find focusing error signal S-curve; in step R5, adjusting levels of the focusing error signal S-curve; in step S6, searching for a best gain value, correcting an asymmetry of focusing error signal to make a positive half period magnitude equal to a negative half period magnitude, and recording a radial voltage and a best gain value of the calibration position; in step R7, checking if a predetermined number of calibration positions are recorded; if the predetermined number of calibration positions is not reached, going back to step R3; if the predetermined number of calibration positions is reached, proceeding to step R8.

In step R8, fitting a best gain curve according to the recorded radial voltages and best gain values; in step R9, rotating the lightscribe disc and moving the pickup head to read a control feature zone; in step R10, deriving a specific best gain value from the best gain curve according to a radial voltage of driving a lens with interpolation or extrapolation; in step R11, calibrating an asymmetry of the focusing error signal of the lightscribe disc to make the positive half period magnitude equal to the negative half period magnitude; and finally, in step R12, after reading the control feature zone, ending the calibration.

Therefore, the focusing error signal calibration method for a lightscribe disc of the present invention can fit a best gain curve with interpolation or extrapolation via best gain values derived from calibrating an asymmetry of a focusing error signal, and can also derive a best gain value for a symmetric focusing error signal to improve a symmetry of the focusing error signal and avoid bad focusing characteristics in the control feature zone, enhancing focusing servo of the control feature zone and therefore lowering the opportunity of focusing failure, resulting in reading data in the control feature zone correctly to scribe a label properly.

Those skilled in the art will readily observe that numerous modifications and alterations of the device and method may be made while retaining the teachings of the invention.

What is claimed is:

1. A method of calibrating a focusing error signal of a lightscribe disc, the steps of the method comprising:
(1) setting a focusing reference surface;
(2) moving a pickup head to the focusing reference surface;
(3) utilizing radial voltages to move a lens to predetermined calibration positions to find and record a best gain value, and calibrating an asymmetry of a focusing error signal of each calibration position;
(4) fitting a best gain curve according to the recorded radial voltages and the best gain values; and
(5) deriving a specific best gain value from the best gain curve according to the radial voltages of the lens to calibrate the asymmetry of the focusing error signal of the lightscribe disc.

2. The method of claim 1, wherein the focusing reference surface is an optical disc.

3. The method of claim 1, wherein in the step (3), the best gain value makes a magnitude of the asymmetric focusing error signal at a positive half period equal to a magnitude of the asymmetric focusing error signal at a negative half period.

4. The method of claim 1, wherein the step (3) comprises adjusting a signal level of the focusing error signal after focusing.

5. The method of claim 1, wherein in the step (5), the specific best gain value is derived by an interpolation or an extrapolation of the best gain value curve.

6. A method of calibrating a focusing error signal of a lightscribe disc, the steps comprising:
(1) placing a lightscribe disc in an optical disc drive without rotating the lightscribe disc;
(2) moving an optical pickup head to a control feature zone of the lightscribe disc and keeping it still;
(3) utilizing predetermined radial voltages to move a lens to a calibration position to perform focusing to find a focusing error signal and adjust a level of the focusing error signal;
(4) searching for a best gain value, correcting an asymmetry of the focusing error signal, and recording a radial voltage and a best gain value of the calibration position;
(5) checking if a predetermined number of calibration positions are recorded; when the predetermined number of calibration positions is not reached, going back to step (3); when the predetermined number of calibration positions is reached; going to step (6);
(6) fitting a best gain curve according to the recorded radial voltages and best gain values;
(7) reading a control feature zone, and deriving a specific best gain value from the best gain curve according to a radial voltage of driving a lens to calibrate an asymmetry of the focusing error signal of the lightscribe disc.

7. The method of claim 6, wherein the predetermined voltages are different radial voltages such that distributed calibration positions are derived.

8. The method of claim 6, wherein the predetermined voltages are equal-difference radial voltages such that distributed calibration positions are derived.

9. The method of claim 6, wherein in the step (4), the best gain value makes a magnitude of the asymmetric focusing error signal at a positive half period equal to a magnitude of the asymmetric focusing error signal at a negative half period.

10. The method of claim 6, wherein the step (4) comprises rotating the lightscribe disc and moving a pickup head to read the control feature zone.

11. The method of claim 6, wherein in the step (7), the specific best gain value is derived by an interpolation or an extrapolation of the best gain value curve.
